(19) United States
(12) Patent Application Publication
(10) Pub. No.: US 2015/0296199 A1
(43) Pub. Date: Oct. 15, 2015

(54) METHOD AND DEVICE FOR DRIVER INFORMATION

(71) Applicant: ROBERT BOSCH GMBH, 70442 Stuttgart (DE)

(72) Inventor: Thomas Fuehrer, Stuttgart-Weilimdorf (DE)

(21) Appl. No.: 14/370,650

(22) PCT Filed: Nov. 6, 2012
(86) PCT No.: PCT/EP2012/071925

§ 371 Date: Jul. 3, 2014

(30) Foreign Application Priority Data
Jan. 5, 2012 (DE) 102012200133.6

(51) Int. Cl. H04N 13/02; G06T 15/20; G02B 27/01; G06T 7/20; G06T 7/60; H04N 13/04; G06T 19/00; G06T 7/00

(52) U.S. Cl. CPC H04N 13/0239; G06T 19/006; G06T 15/20; G06T 7/0046; G06T 7/0071; G06T 7/0087; G06T 7/2006; G06T 7/2093; G06T 7/602; H04N 13/0271; H04N 13/0282; H04N 13/0429; G02B 27/01; G06T 2219/2008; G06T 2219/2004; G06T 2219/004; G06T 2200/04; G06T 2200/21; G06T 2207/10004; G06T 2207/10016; G06T 2207/10028; G06T 2207/20144; G06T 2207/30252

(57) ABSTRACT

A method for driver information includes: sensing an image of an outer area of a motor vehicle, determining a coherent display area in the image, determining personalized information directed to a driver of the motor vehicle, inserting the information into the image in the area of the display area; and outputting the image to the driver. A system for driver information onboard a motor vehicle includes: a pickup device for sensing an image of the outer area of a motor vehicle, a determination device for determining personalized information directed to a driver of the motor vehicle, a processing device for determining a coherent display area in the image and for inserting the information into the image in the area of the display area, and an output device for outputting the image to the driver.

### BACKGROUND OF THE INVENTION

1. Field of the Invention

The present invention relates to a method and a device for outputting personalized information to a driver of a motor vehicle.

2. Description of the Related Art

It is known that one may utilize optical, acoustic or haptic output devices for outputting information to a driver of a motor vehicle. These devices are utilized, first of all, for outputting information on the driving state of the motor vehicle, for instance, an optical speed indicator (tachometer) or a haptic warning before leaving a traffic lane. Since the output of such information involves the danger of distracting the driver from an event in the surroundings of the motor vehicle, such outputs always have to take place with caution. In certain cases one also has to observe legal requirements, such as, in some countries, operating a navigation system being inadmissible while driving.

Information that does affect the driver, but is not directly linked to the tasks of the driver of the motor vehicle, are therefore frequently not passed on to the driver of the motor vehicle. In this context, it would be desirable also to supply the driver with information that goes beyond his current activity of guiding the motor vehicle. The present invention is therefore based on the object of providing a method and a device for personalized driver information for a driver of a motor vehicle.

### BRIEF SUMMARY OF THE INVENTION

A method according to the present invention for driver information includes steps of sensing an image of an outer area of a motor vehicle, determining a coherent display area in the image, determining personalized information that is directed to a driver of the motor vehicle, inserting the information into the image in the area of the display area and outputting the image to the driver.

It is thereby possible to present personalized information to the driver optically, without diverting his attention greatly from the task of guiding the motor vehicle. Thereby traffic safety of the motor vehicle is able to be ensured and legal regulations for avoiding distracting the driver are able to be satisfied.

In one preferred specific embodiment, the display area includes a surface of the object shown in the image. In this case, the method is able to carry out a recognition of objects in the image, and provide a surface of a detected object as the display area. Thus a coherent display area may be found in a simple manner. In addition, the surface of the object may contain little or no information at all for guiding the motor vehicle, so that superposing with the personalized information represents practically no information loss for the driver. In one further specific embodiment, advertising information on the surface of the object may be faded out by the personalized information.

The representation of the inserted information is preferably adjusted perspectively to a position and an extent of the surface of the object with respect to the motor vehicle. In this way, the output of the personalized information may take place in agreement with the perceptible objects of the environment, so that the uptake of the information by the driver may be simplified.

The information may be obtained from a source outside the motor vehicle. In particular, the information may be obtained, using wireless data transfer, for example, from a computer or a computer network, which provides the personalized information for the driver. Thus, for example, calendar or contact information, reminders or personalized advertising may discreetly be brought to the attention of the driver.

In one further preferred specific embodiment, the method includes determining a driving situation of the motor vehicle and selecting the information to be inserted as a function of the driving situation. If a driving situation, because of its complexity, for instance, requires an increased degree of attention from the driver, the personalized information may be limited to short messages and messages marked as being urgent. However, if the driving situation is simple, such as driving at constant speed on an expressway that is only minimally traveled during daylight and good visibility, the information may also be more complex and may be changed more frequently.

The driving situation may be determined, for instance, based on the purpose of travel, a time of day or a driving speed. In that way, overloading the driver with information may be prevented even better. In addition, the personalized information may be output fittingly to the driving situation, so that, for example, on business travel a current appointments plan may be output, but on a vacation trip, personalized weather information for the place of destination as well.

A computer program product has program code means for carrying out the method described when it is run on a processing device or is stored on a computer-readable data carrier.

The computer program product may especially run on a processing device that is integrated into the motor vehicle and, if necessary, is also controlling another system, such as a navigation system. The computer program product may also run on a computer that is removable from the motor vehicle, alternatively an integrated output device or an output device that is permanently installed in the motor vehicle being utilized.

One system for driver information according to the present invention includes a pickup device for sensing an image of the outer area of a motor vehicle, a determination device for determining personalized information directed to a driver of the motor vehicle, a processing device for determining a coherent display area in the image and for inserting the information into the image in the area of the display area, and an output device for outputting the image to the driver.

In one preferred specific embodiment, the system is permanently installed in the motor vehicle. For this reason, networking with other systems of the motor vehicle may particularly be easier, in order perhaps to permit an improved or easier determination of the driving situation of the motor vehicle.

In one especially preferred specific embodiment, the output device includes a so-called head-up display. Such an optical output device allows superposing the directly visually perceivable surroundings by a generated image. In this instance, superposing only in subareas of the surroundings may take place, perhaps using an alphanumeric output. A context-sensitive superposing of visually perceivable objects by additional information is designated as augmented reality. This technique may be used advantageously to carry out the output to the driver, according to the present invention.

Furthermore, the system preferably includes a receiving device for receiving the information from a source outside the motor vehicle. The receiving device may particularly include a unidirectional or a bidirectional digital data interface, which is connected to a computer or a computer network, such as the Internet.

### BRIEF DESCRIPTION OF THE DRAWINGS

FIG. 1 shows a system for driver information.

FIGS. 2-4 show examples of superposing optically perceivable information by output personalized information.

FIG. 5 a shows flow chart of a method for carrying out the method on the system in FIG. 1.

### DETAILED DESCRIPTION OF THE INVENTION

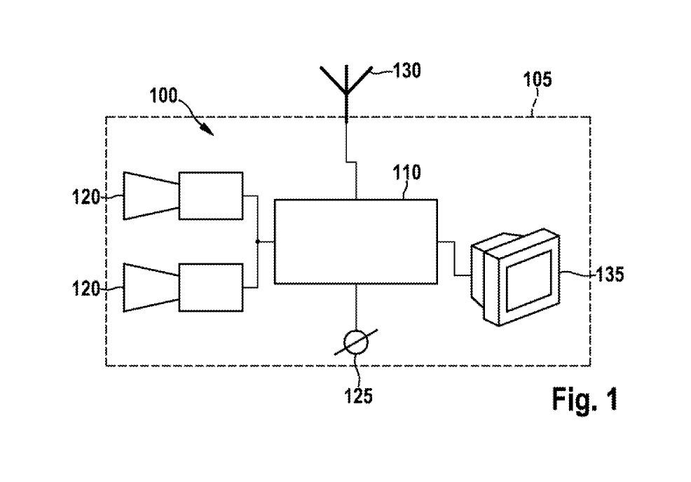

FIG. 1 shows a system 100 for driver information. Onboard a motor vehicle 105, there are located a processing device 110, a first camera 115, a second camera 120, an interface 125, a receiving device 130 and an output device 135. In different specific embodiments of system 100, not all the elements shown have to be present, as will be stated more exactly in the following text.

Processing device 110 preferably includes a programmable microcomputer. In one specific embodiment, processing device 110 is permanently installed onboard motor vehicle 105, processing device 110 in connection with the devices connected to it being able to take on even additional processing and control tasks. For example, processing device 110 may be a part of a navigation system or an entertainment system onboard motor vehicle 105.

First camera 115 and second camera 120, which may also be substituted by a stereo camera, are equipped to provide images, or rather a combined image of an outer area of motor vehicle 105. A viewing angle of cameras 115 and 120 preferable corresponds as exactly as possible to a viewing angle of the driver of motor vehicle 105. Cameras 115 and 120 are preferably aligned forwards in the travel direction, and besides that, are mounted offset to each other, so that images that were taken at the same time using the two cameras 115, 120, are able to be put one on top of the other, for determining depth information. The determination of depth information in the combined image may take place either in cameras 115, 120 or the stereo camera replacing them, or using processing device 110. In one additional specific embodiment, only a single camera 115 is provided and depth information of the image provided by this camera 115 are able to be determined by a geometrical distance estimation.

Optional interface 125 is equipped to provide data which point to a driving state of motor vehicle 105. Such data may include a position, a speed, an acceleration, a planned route, a time of day, an outside temperature, illumination conditions and other parameters which are important for the operation of motor vehicle 105. Based on the information provided, processing device 110 is able to determine the driving state of motor vehicle 105.

Receiving device 130 is likewise optional, and is equipped to receive personalized information directed to the driver of motor vehicle 105. Receiving device 130 may be cable-bound or be connected in a wireless manner to a data memory onboard motor vehicle 105, for instance, to a mobile phone or a personalized computer, for managing appointments, for example. Receiving device 130 may also be equipped, however, for the wireless reception of data from a network. This network may include a mobile radio network, for example, which is also connected to the Internet. In one preferred specific embodiment, receiving device 130 may also be equipped to transmit a request for personalized data from processing device 110 to another computer, which then provides these data.

Output device 135 is an optical output device, preferably having the support of a multi-colored output. Output device 135 is installed in such a way that the driver of motor vehicle 105 is easily able to read off from it. In one simple specific embodiment, output device 135 includes a freely viewable display, such as a liquid crystal display. In one preferred specific embodiment, output device 135 includes a so-called head-up display, which is equipped to reflect data into the viewing range of the driver. In this context, the viewing range of cameras 115 and 120 includes the essential viewing range of the driver, so that the directly viewable optical data from the surroundings of motor vehicle 105 based on the images provided by cameras 115, 120 are able to be superposed using output device 135. It is determined by the superposing which objects in the surroundings of motor vehicle 105 are visible to the driver and which are wholly or partially superposed by information of the image.

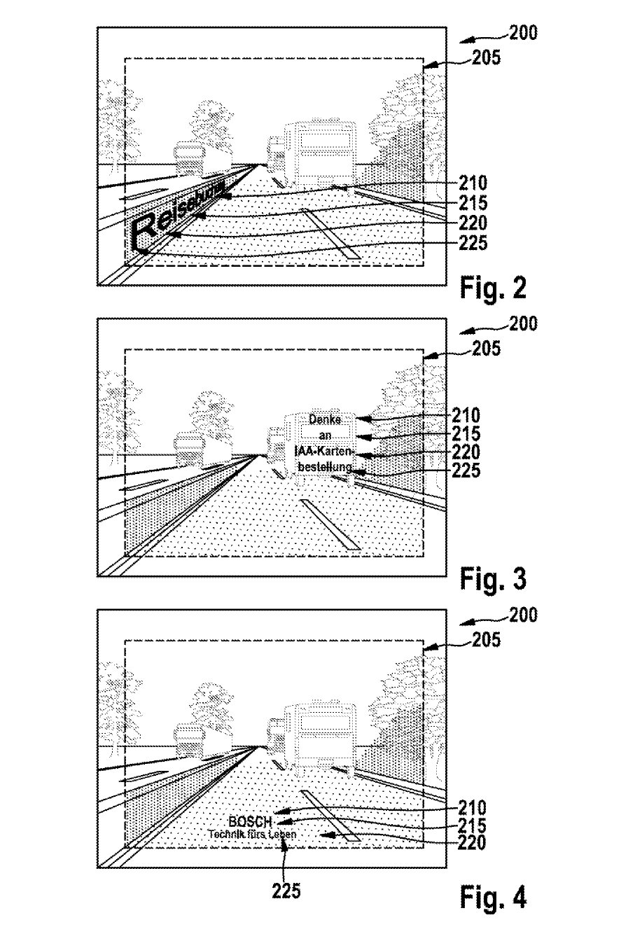

FIGS. 2-5 show examples of superposing optically perceivable information by output personalized information. In each case, a region 200 is shown, which lies in front of motor vehicle 105 and which is able to be viewed by the driver of motor vehicle 105 by casting a glance in the driving direction. From region 200 one is able to infer an image 205, which was taken using cameras 115, 120 and processed using processing device 110 of FIG. 1. Image 205 is preferably faded into region 200 in such a way that objects perceivable directly from region 200 and representations of these objects in image 205 are coincident with each other, so that additional information of image 205 fall on predetermined areas of the field of view of the driver. In another specific embodiment, image 205 is not completely reproduced for the driver but includes only additional information which are superposed in an exactly fitting manner on directly visible objects.

In each representation of FIGS. 2 through 4, in each case an object 210, an area 215 of the respective object 210 and a graphic representation of information 220 are shown. For this, processing device 110 carries out in each case an object detection on image 205. For each object 210 detected, one or more surfaces 215 may be determined, based on which a coherent display surface 220 is determined. For this purpose, a plurality of areas 215 of one or more objects 210 may be taken together.

In FIG. 2 object 210 includes a guardrail. Display area 220 corresponds to the visible surface of the guardrail, and information 225, which is shown on display area 220, concerns a travel booking that is due, which the driver of motor vehicle 105 has to take care of.

In FIG. 3, object 210 is a truck and area 215 is its rear periphery. The personalized information 225 refers, for instance, to an ordering of tickets that is due by the driver of motor vehicle 105, which is superposed on the periphery.

In FIG. 4, object 210 is an area of the road lying ahead of motor vehicle 105, and the surface of the road forms the display area. The personalized information 225 shown relate to a general product information that is being presented to the driver.

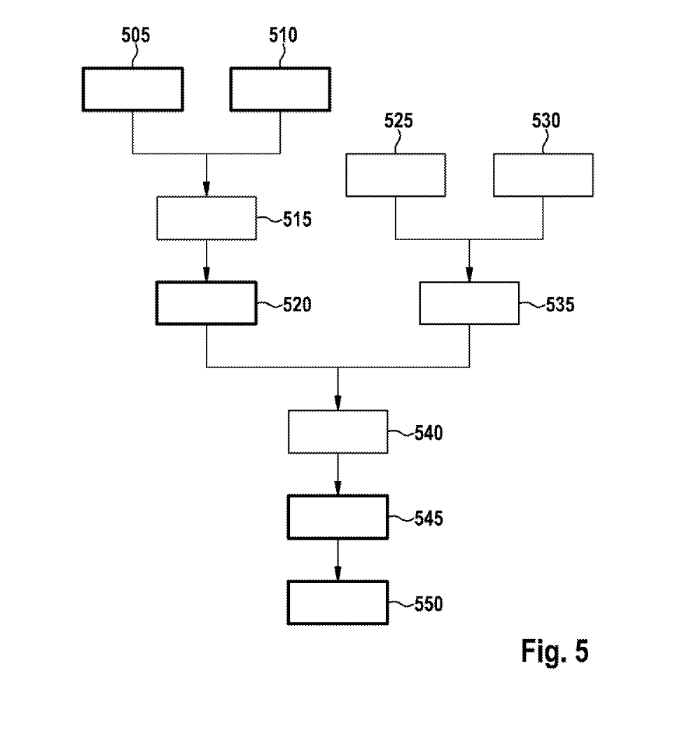

FIG. 5 shows a flow chart of a method 500 for driver information of the driver of motor vehicle 105 of FIG. 1. Method 500 is particularly equipped to be carried out on processing device 110 of system 100 in FIG. 1.

Method 500 includes steps 505 to 550, in the simplest possible specific embodiment only those steps being required which are shown edged in bold. The remaining steps are optional, and may also be omitted in other specific embodiments.

In steps 505 and 510, an image 205 is produced in each case, as simultaneously as possible using cameras 115 and 120. If only one camera 115 is used, steps 505 and 510 merge into one.

In a following step 515, an object detection is carried out, in order to record objects 210, which are shown on image 205. If image 200 was taken by the two cameras 115, 120 or by a stereo camera, a determination may previously be carried out of depth information in image 200, and the object detection in step 515 may additionally be supported by the depth information.

Subsequently, in a step 520, a coherent display area is determined in image 205. For this, one may draw upon individual surfaces of objects determined in step 515. An area 215 of an object 210 or a plurality of areas 215 of one or more objects 210 may together form display area 220.

Independently of steps 505 to 520 described up to this point, in a step 525, personalized information directed to the driver of motor vehicle 105 is obtained. This personalized information is preferably received using receiving device 130 in FIG. 1. In addition, in a step 530, based on the information included in image 205 and/or information provided via interface 525 by other systems of motor vehicle 105, a driving state of motor vehicle 105 may be determined.

In a step 535, personalized information to be shown is selected, based on information obtained in step 525. If necessary, the selection may be made based on the driving state of motor vehicle 105 determined in step 530.

In an optional step 540, the information selected in step 535 may be perspectively enlarged, diminished, rotated or distorted for showing them on display area 220.

In a further step 545, the information is inserted into image 205, and then, in a step 550 are output to the driver of motor vehicle 105. There are examples of possible outputs in FIGS. 2 to 4.

1-10. (canceled)

11. A method for displaying information to a driver of a motor vehicle, comprising:
detecting, by an image sensor, an image of a surrounding area of the motor vehicle;
determining a coherent display area in the image;
selecting a personalized information directed to the driver of the motor vehicle;
inserting the personalized information into the area of the coherent display area in the image; and
outputting, by an image output device, the image to the driver.

12. The method as recited in claim 11, wherein the coherent display area is the surface of an object shown in the image.

13. The method as recited in claim 12, wherein the representation of the inserted personalized information is perspectively adjusted to a position and an extension of the surface of the object with respect to the motor vehicle.

14. The method as recited in claim 12, wherein the personalized information is received from a source outside the motor vehicle.

15. The method as recited in claim 12, further comprising:
determining a driving situation of the motor vehicle;
wherein the personalized information to be inserted is selected as a function of the determined driving situation.

16. The method as recited in claim 15, wherein the driving situation includes at least one of a driving purpose, time of day, and driving speed.

17. A non-transitory, computer-readable data storage medium storing a computer program having program codes which, when executed on a computer, performs a method for displaying information to a driver of a motor vehicle, the method comprising:
detecting, by an image sensor, an image of a surrounding area of the motor vehicle;
determining a coherent display area in the image;
selecting a personalized information directed to the driver of the motor vehicle;
inserting the personalized information into the area of the coherent display area in the image; and
outputting, by an image output device, the image to the driver.

18. A system for displaying information to a driver of a motor vehicle, comprising:
an image sensing device for sensing an image of a surrounding area of the motor vehicle;
a selection device for selecting a personalized information directed to the driver of the motor vehicle;
a processing device configured for (i) determining a coherent display area in the image, and (ii) inserting the personalized information into the area of the coherent display area in the image; and
an image output device for outputting the image to the driver.

19. The system as recited in claim 18, wherein the image output device includes a heads-up display.

20. The system as recited in claim 19, further comprising:
a receiving device for receiving the personalized information from a source outside the motor vehicle.
